(19) United States
(12) Patent Application Publication
(10) Pub. No.: US 2014/0374978 A1
(43) Pub. Date: Dec. 25, 2014

(54) FIXTURE FOR A COUPLING ASSEMBLY

(71) Applicant: Caterpillar Inc., Peoria, IL (US)

(72) Inventors: Daniel L. Loer, Brimfield, IL (US); Rama K. Nandamuri, Peoria, IL (US)

(73) Assignee: Caterpillar Inc., Peoria, IL (US)

(21) Appl. No.: 14/479,384

(22) Filed: Sep. 8, 2014

(51) Int. Cl. B23Q 3/18

(52) U.S. Cl. CPC B23Q 3/18
USPC 269/290

(57) ABSTRACT

A fixture for assembling a coupling assembly is provided. The fixture includes a base member having a top surface and a bottom surface distal to the top surface. The base member is configured to receive the coupling assembly on the top surface. A plurality of projections extends from the top surface of the base member. Each projection defines a hollow portion configured to receive a bolt head of a corresponding bolt of the plurality of bolts. The hollow portion has a shape complementary to a shape of the bolt head to rotationally restrict the corresponding bolt relative to the opening of the coupling assembly. A support member is mounted on the bottom surface of the base member and configured to position the base member at an elevated position with respect to a working surface.

### TECHNICAL FIELD

The present disclosure relates to a fixture, and more particularly to a fixture for assembling a coupling assembly.

### BACKGROUND

A typical spring type torsional coupling is common to the mobile machine industry and is typically employed to transfer rotation of an engine's crankshaft to a transmission assembly. The torsional coupling includes a first plate and a second plate and a middle plate sandwiched between the first and second plates and is mounted to the crankshaft. The middle plate captures a set of compression springs that are used to transfer rotation to the first and second plates and acts as a resilient coupling to avoid damaging drive components in the transmission assembly in the event the crankshaft suddenly stops or if a significant load is suddenly applied to the crankshaft. The first plate and the second plate are bolted together by threaded bolts extended through the face of the first plate and nuts are usually threaded on the bolt portions extended outwardly from the face of the second plate. In a conventional method of assembling the torsional coupling, the bolts are inserted from one side of the torsional coupling and the corresponding nuts are engaged with the bolts from other side of the torsional coupling. In such case, the nut is rotationally retained from the other side of the torsional coupling by a wrench and then the bolt is tightened by another wrench such as a pneumatic torque wrench. As both the nut and bolt are manually handled during the assembly of the torsional coupling, it is often cumbersome to set up and align the fasteners and at the same time ensure that the internal springs and middle plate do not move.

German Patent Number 29511870 (the '870 patent) discloses a carrying disk member including bolts engaged with corresponding nuts. At least two of the bolts receive nuts and a ring fixture is employed to hold the nut as the threaded bolts are threaded on the nuts. The ring fixture includes 4 equally spaced hexagonal tube members which are fixed to the ring fixture and the ring fixture in turn may be positioned to secure the nuts so that they don't rotate as the carrying disk member is being assembled. The '870 may lack a robust construct so that the assembly person can easily position the fixture and the corresponding assembly in a manner that is ergonomically effective and productive for high volume assembly operations.

### SUMMARY OF THE DISCLOSURE

In one aspect of the present disclosure, a fixture for assembling a coupling assembly is provided. The coupling assembly includes a plurality of openings configured to receive a plurality of bolts therethrough. The fixture includes a base member having a top surface and a bottom surface distal to the top surface. The base member includes a central axis and configured to receive the coupling assembly on the top surface thereof. The fixture further includes a plurality of projections extending from the top surface of the base member. Each of the plurality of projections is angularly spaced about the central axis. Further, each of the plurality of projections defines a hollow portion that is configured to receive a bolt head of a corresponding bolt of the plurality of bolts. The hollow portion has a shape complementary to a shape of the bolt head to rotationally restrict the corresponding bolt relative to the opening of the coupling assembly. A support member is mounted on the bottom surface of the base member. The support member is configured to position the base member at an elevated position with respect to a working surface.

Other features and aspects of this disclosure will be apparent from the following description and the accompanying drawings.

### BRIEF DESCRIPTION OF THE DRAWINGS

FIG. 1 is a perspective view showing a fixture and an exemplary coupling assembly disposed on the fixture, according to an embodiment of the present disclosure;

FIG. 2 is a sectional view of the fixture and the coupling assembly taken along A-A′ of FIG. 1;

FIG. 3 is a perspective view of the fixture, according to an embodiment of the present disclosure;

FIG. 4 illustrates tightening of a set of nuts of the coupling assembly of FIG. 1 , according to an embodiment of the present disclosure; and

FIG. 5 illustrates a perspective view of the assembled coupling assembly being removed from the fixture, according to an embodiment of the present disclosure.

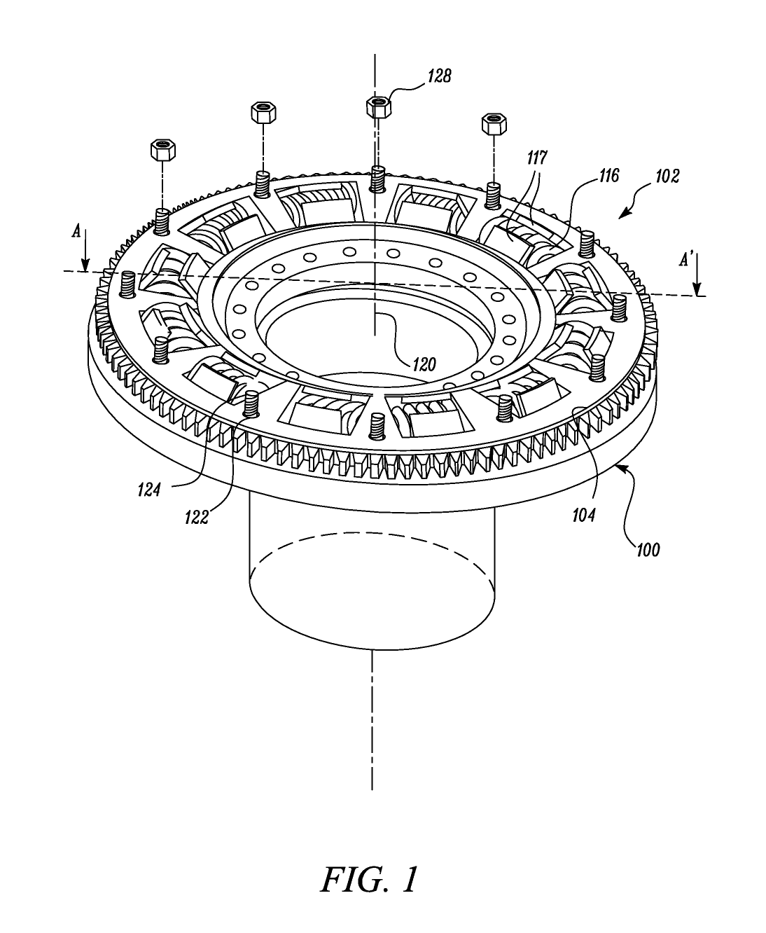

### DETAILED DESCRIPTION

Wherever possible, the same reference numbers will be used throughout the drawings to refer to the same or the like parts. FIG. 1 shows a perspective view of a fixture 100, according to an embodiment of the present disclosure. Further, an exemplary coupling assembly 102 is disposed on the fixture 100. The coupling assembly 102 may be used between a driving member (not shown) and a driven member (not shown) for selectively transmitting power from the driving member to the driven member. In an example, the driving member may be a crankshaft of an engine and the driven member may be a transmission assembly. The coupling assembly 102 may also be used for dampening torsional vibration when power is transmitted between the driving member and the driven member. In the embodiment of FIG. 1, the coupling assembly 102 is a spring type torsional coupling.

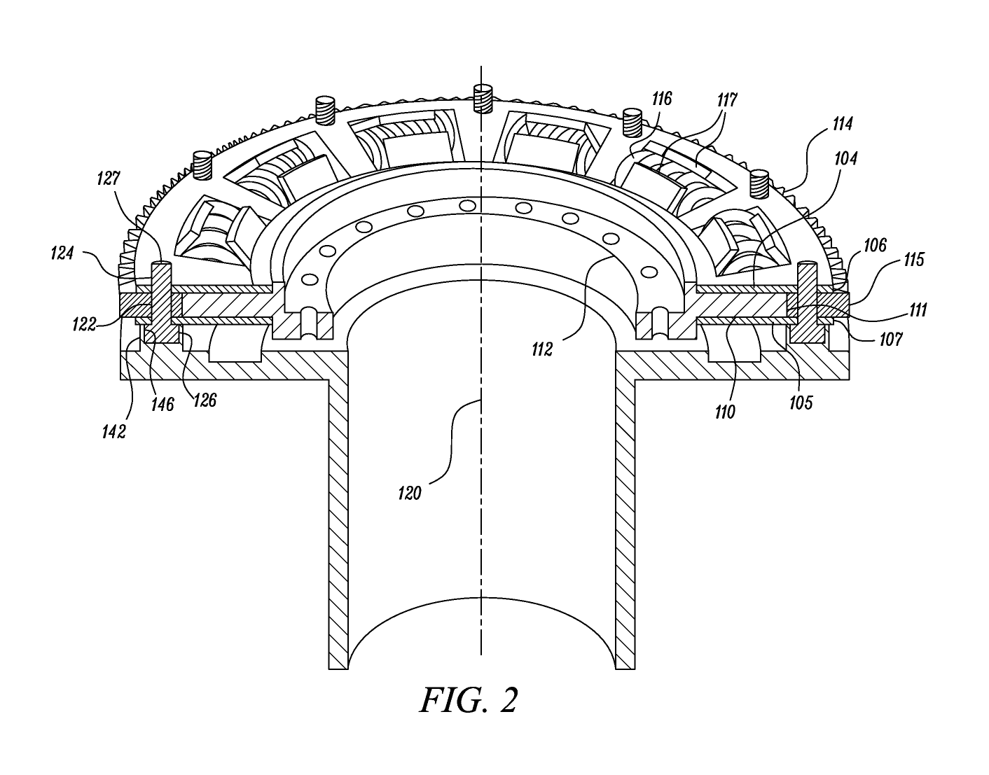

FIG. 2 shows a sectional view of the fixture 100 and the coupling assembly 102 taken along A-A′ of FIG. 1. Referring to FIGS. 1 and 2, the coupling assembly 102 includes a first plate 104 having an outer circumference 106 and a second plate 105 having an outer circumference 107. The coupling assembly 102 further includes a middle plate 110 disposed between the first plate 104 and the second plate 105. The middle plate 110 has an inner circumference 112 defining an opening about an axis 120. In the embodiment of FIG. 1, an annular ring 115 having a set of teeth 114 being disposed on an outer circumference 111 of the middle plate 110. The middle plate 110 includes a set of openings (not shown) spaced angularly about the axis 120. Each of the set of openings is configured to receive a coil spring 116. The coil spring 116 is retained from both sides of the middle plate 110 by a pair of tabs 117 projecting from the first plate 104 and the second plate 105. As shown in FIGS. 1 and 2, the pair of tabs 117 being disposed in contact with the coil spring 116 to secure the coil spring 116 therebetween.

Further, the first plate 104, the second plate 105 and the annular ring 115 of the coupling assembly 102 together defines a set of openings 122 adjacent to the outer circumference 106 of the first plate 104. Each of the set of openings 122 are angularly spaced about the axis 120. An angular distance between the adjacent openings 122 may be equal. Further, each of the set of openings 122 is configured to receive a bolt 124 therethrough. The bolt 124 includes a bolt head 126 and a shank 127. The shank 127 of the bolt 124 is provided with external threads configured to engage with corresponding internal threads of a nut 128. In FIG. 1, it will be understood that all the nuts 128 will be secured to corresponding bolts 124 to form coupling assembly 102, however in the FIG. 1, a portion of the nuts 128 are shown and some are removed for the purpose of clearly illustrating the present disclosure. In the embodiment of FIG. 2, the bolt head 126 has a hexagonal cross-section as is customary, however those having ordinary skill will appreciate any known type of bolt head may be employed. The bolts 124 may be inserted through the first plate 104 and on through to the second plate 105 with the shank 127 of the bolts 124 cantilevered outward from the second plate 105. Alternatively, the bolts 124 may be inserted through the second plate 105, and accordingly, the shank 127 of the bolts 124 would be cantilevered outward from the first plate 104. In an example, the coupling assembly 102 is disposed between the crankshaft of the engine and the transmission assembly by coupling the middle plate 110 with the crankshaft and coupling the annular ring 115 with the transmission assembly. Alternatively, the annular ring 115 is coupled to the crankshaft and the middle plate 110 is coupled to the transmission assembly.

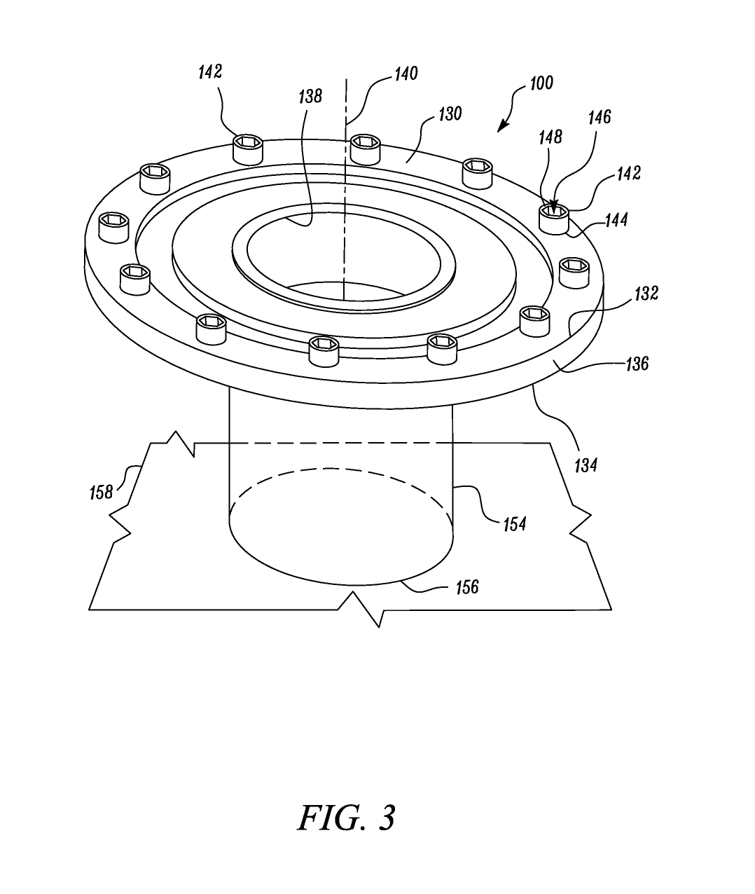

FIG. 3 shows a perspective view of the fixture 100, according to an embodiment of the present disclosure. The fixture 100 includes a base member 130 having a top surface 132 and a bottom surface 134 distal to the top surface 132. The base member 130 includes an outer circumference 136 that has a diameter larger than a diameter of the outer circumference 106 of the first plate 104. However, it may be contemplated that the base member 130 may have any alternative shape, such as elliptical, polygonal, and the like. In exemplary embodiment, the base member 130 further includes an inner circumference 138 along a central axis 140 thereof. The top surface 132 of the base member 130 extends between the outer circumference 136 and the inner circumference 138 to receive the coupling assembly 102 thereon. The top surface 132 may be further configured to be a complementary surface to align with a surface of one of the first plate 104 and the second plate 105.

The base member 130 further includes a set of projections 142 extending from the top surface 132 adjacent to the outer circumference 136. Each of the set of projections 142 is angularly spaced about the central axis 140. The set of projections 142 correspond to the set of openings 122 provided in the coupling assembly 102. One of the set projections 142 is considered for detailed illustration herein below. The projection 142 is a cylindrical body having a first end 144 disposed on the top surface 132 of the base member 130. Although an outer surface of the projection 142 has a cylindrical shape, it may be contemplated that the outer surface may have any alternative shapes such as, for example, cuboidal. The first end 144 of the projection 142 may be coupled to the top surface 132 by various methods known in the art, for example, welding, press-fitting etc. Alternatively, the projection 142 may be integrally formed with the base member 130.

Referring to FIG. 2 and FIG. 3, the projection 142 further defines a hollow portion 146 extending from the first end 144 towards a second end 148. The second end 148 is distal from the first end 144. The hollow portion 146 is configured to receive the bolt head 126 of the bolt 124. Further, the hollow portion 146 includes an internal surface having a cross-sectional shape complementary to a shape of the bolt head 126. In the embodiment of FIG. 3, the cross-sectional shape of the hollow portion 146 is hexagonal so as to receive the hexagonal bolt head 126. Further, the complementary shape of the hollow portion 146 would rotationally restrict the bolt 124 relative to the opening 122. Specifically, the bolt 124, when received within the hollow portion 146, would be restricted to rotate with respect to the opening 122. It may be apparent to a person of ordinary skill in the art that the cross-sectional shape of the hollow portion 146 may vary according to the shape of the bolt head 126. In an alternative embodiment, the hollow portion 146 may be configured to receive the nut 128. In such a case, the internal surface of the hollow portion 146 may include a cross-sectional shape complementary to a shape of the nut 128. Further, a number of the projections 142 may also vary as per the number of openings 122 and hence, the number of the bolts 124. Additionally, an angular distance between adjacent projections 142 may be substantially equal to the angular distance between adjacent openings 122.

The fixture 100 further includes a support member 154 mounted on the bottom surface 134 of the base member 130. In the embodiment of FIG. 3, the support member 154 is a hollow cylindrical body having a first end (not shown) configured to be mounted on the bottom surface 134. The support member 154 may also have alternative shapes, for example, cuboidal. The support member 154 may be further coaxially mounted on the base member 130. The support member 154 may further include a second end 156 distal from the first end. The second end 156 is configured to be placed on a working surface 158. In other embodiments, the second end 156 may be detachably fixed to the working surface 158 via mechanical fasteners, tongue and groove couplings, and the like. Moreover, the second end 156 may have a larger area with respect to the first end to increase area of contact of the fixture 100 with the working surface 158, thereby providing increased stability. A length of the support member 154 defined between the first end and the second end 156 may be varied in order to position the base member 130 at an elevated position with respect to the working surface 158.

### INDUSTRIAL APPLICABILITY

The present disclosure relates to the fixture 100 for supporting the coupling assembly 102 at an elevated position with respect to the working surface 158. A bottom side defined by one of the first plate 104 and the second plate 105 may be aligned with the top surface 132 of the coupling assembly 102 such that the set of projections 142 receive bolt heads 126 of the corresponding bolts 124. The corresponding nuts 128 are then engaged with the shank 127 of the bolts 124 and tightened from a top side of the coupling assembly 102.

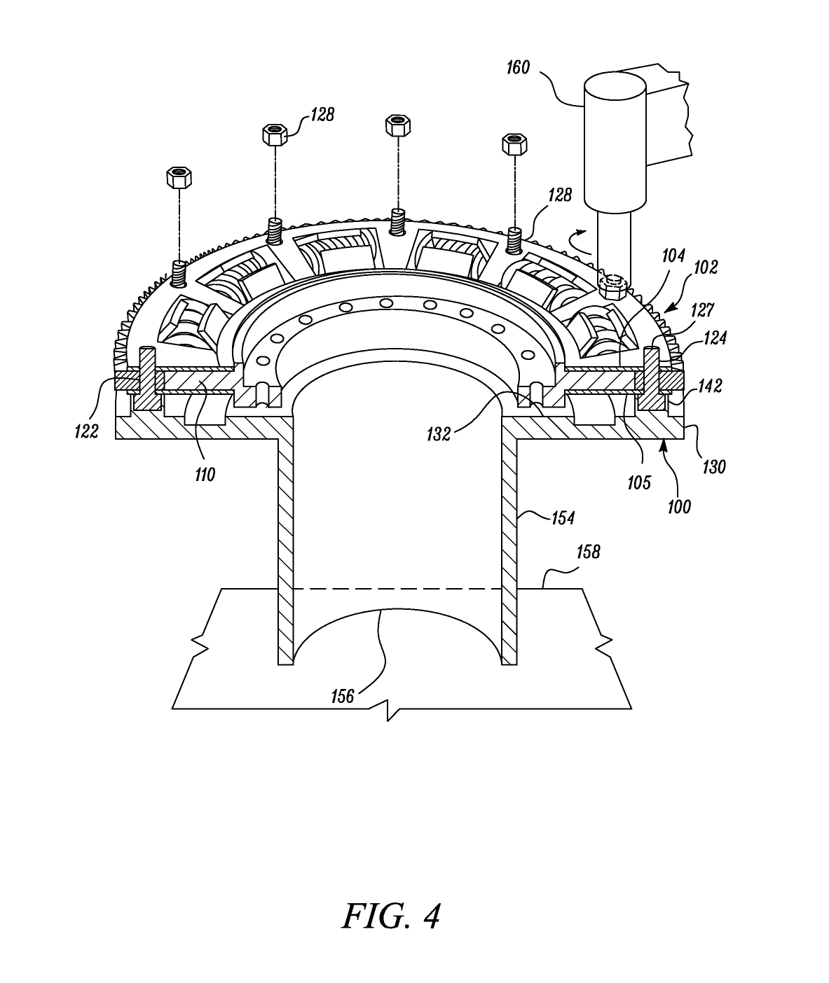

FIG. 4 illustrates tightening of the nuts 128 of the coupling assembly 102, according to an embodiment of the present disclosure. The fixture 100 is placed on the working surface 158 such that the second end 156 of the support member 154 contacts with the working surface 158 and the base member 130 are disposed at an elevated position to facilitate assembly of the coupling assembly 102 by an operator. Optionally, the fixture 100 may be detachably coupled to the working surface 158. After placing the fixture 100 on the working surface 158, the set of bolts 124 is inserted within the respective projections 142. The set of bolts 124 may be lubricated before being inserted within the projections 142. In an example, the bolts 124 may be lubricated by one of lubrication oil and grease. Specifically, the bolt head 126 of the bolt 124 is inserted within the hollow portion 146 of the projections 142. The shank 127 of the bolts 124 extends upward from the projections 142. After inserting the bolts 124 within the projections 142, the first plate 104, the middle plate 110 and the second plate 105 are positioned on the fixture 100. The shanks 127 of the bolts 124 are be aligned with the corresponding openings 122 of the coupling assembly 102.

When the first plate 104, the middle plate 110 and the second plate 105 of the coupling assembly 102 is positioned on the fixture 100, an end portion of each of the shanks 127 projects from the first plate 104. The end portion of the shank 127 of each of the bolts 124 is engaged with the nut 128 manually. The nuts 128 may be lubricated before being engaged with the shanks 127 of the corresponding bolts 124. The operator may use a hand-held tool 160 to apply an equal amount of torque on each nut 128. The hand-held tool 160 may be a powered wrench such as, for example, pneumatic wrench. As the bolt heads 126 engage with the corresponding hollow portions 146 of the fixture 100, the bolts 124 are be restricted from rotating relative to the openings 122. Restricting the bolts 124 from any rotational movement may ensure tightening of the corresponding nuts 128 with minimal variation of tightening torque across the sets of bolts 124 and nuts 128. Thereby, the first plate 104, the second plate 105 and the middle plate 110 are coupled with each other by the set of bolts 124 and the corresponding nuts 128 and tightened by a substantially equal amount of torque.

In an alternative embodiment, after placing the fixture 100 on the working surface 158, the set of nuts 128 may be disposed within the respective projections 142. The nuts 128 may be lubricated before being disposed within the projections 142. The first plate 104, the middle plate 110 and the second plate 105 of the coupling component 102 may be positioned on the fixture 100 in order to align the openings 122 of the coupling component 102 with the corresponding nuts 128 disposed in the projections 142. The bolts 124 may be inserted through the respective openings 122 and may be partially engaged with the respective nuts 128. The operator may then use the hand-held tool 160 to apply an equal amount of torque on each bolt 124. As the nuts 128 are engaged with the corresponding hollow portions 146 of the fixture 100, the nuts 128 may be restricted from rotating relative to the shank 127 of the bolt 124 during application of the tightening torque on the bolt heads 126.

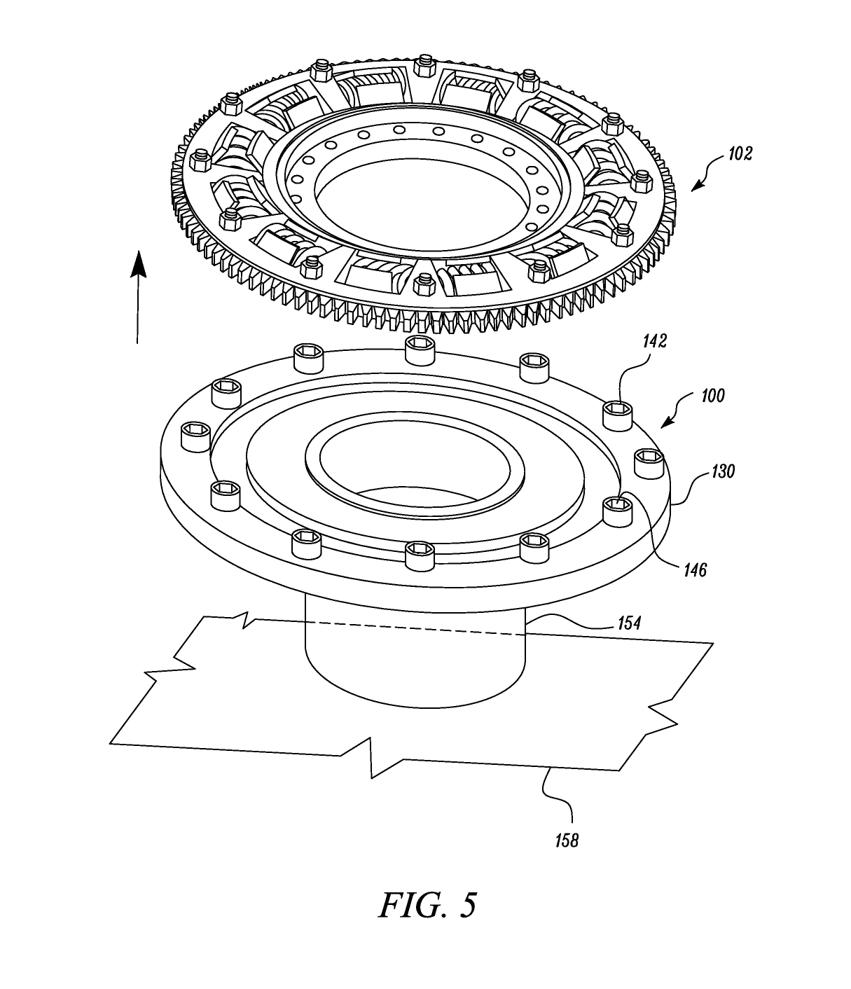

FIG. 5 illustrates a perspective view of the assembled coupling assembly 102 being removed from the fixture 100, according to an embodiment of the present disclosure. After tightening the nuts 128 of the corresponding set of bolts 124, the coupling assembly 102 and the fixture 100 are separated from each other. Tightening the nuts 128 may create a tight fit between the head 126 of the bolts 124 and the corresponding projections 142 of the fixture 100. Hence, lubrication of the bolts 124 may facilitate separation of the coupling assembly 102 from the fixture 100. In an example, the coupling assembly 102 may be manually removed from the fixture 100. While the coupling assembly 102 is being removed from the fixture 100, the bolt heads 126 disengages from the corresponding hollow portion 146 of the projections 142.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A fixture for assembling a coupling assembly having a plurality of openings configured to receive a plurality of bolts therethrough, the fixture comprising:
a base member having a top surface and a bottom surface distal to the top surface, the base member defining a central axis passing therethrough, the base member configured to receive the coupling assembly on the top surface thereof;
a plurality of projections extending from the top surface of the base member, each of the plurality of projections angularly spaced about the central axis, each of the plurality of projections defining a hollow portion therein, wherein the hollow portion is configured to receive a bolt head of a corresponding bolt of the plurality of bolts, the hollow portion having a shape complementary to a shape of the bolt head to rotationally restrict the corresponding bolt relative to the opening of the coupling assembly; and
a support member mounted on the bottom surface of the base member, the support member configured to position the base member at an elevated position with respect to a working surface.
